(19) United States
(12) Patent Application Publication
(10) Pub. No.: US 2026/0290657 A1
(43) Pub. Date: Sep. 24, 2026

(54) METAL PLATE RESISTOR AND METHOD FOR MANUFACTURING METAL PLATE RESISTOR

(71) Applicant: KOA CORPORATION, Ina-shi, Nagano (JP)

(72) Inventors: Michio Kubota, Ina-shi (JP); Hiromitsu Kitahara, Ina-shi (JP)

(73) Assignee: KOA CORPORATION, Ina-shi, Nagano (JP)

(21) Appl. No.: 19/471,733

(22) PCT Filed: Feb. 16, 2024
(86) PCT No.: PCT/JP2024/005575

§ 371 Date: Oct. 2, 2025

(30) Foreign Application Priority Data
Apr. 7, 2023 (JP) 2023-062481

(51) Int. Cl. H01C 1/02; H01C 13/00; H01C 17/02

(52) U.S. Cl. CPC H01C 1/02; H01C 13/00; H01C 17/02

(57) ABSTRACT

The present invention relates to a metal plate resistor and a method for manufacturing the metal plate resistor. The metal plate resistor (1) includes a plate-shaped resistive element (6) made of a metal material. The resistive element (6) has a first slit (10A (10B)), a second slit (10B (10A)), and a through hole (11).

### TECHNICAL FIELD

The present invention relates to a metal plate resistor and a method for manufacturing the metal plate resistor.

### BACKGROUND ART

It is known to use a current detection resistor to monitor a current for controlling the charge/discharge current of a secondary battery. The current detection resistor is incorporated in a path of the current to be monitored, and the voltage generated across the resistor by the current is detected, and the current is detected from a known resistance value.

### CITATION LIST

### Patent Literature

Patent document 1: Japanese laid-open patent publication No. H06-020802

### SUMMARY OF INVENTION

### Technical Problem

Among the types of resistors, there is a metal plate resistor that has a structure in which a thermoplastic resin (LPC) is coated onto a metal plate by injection molding. In recent years, with a miniaturization of electronic devices, there has been a demand for smaller resistors. However, when manufacturing the metal plate resistor, as a size of the resistor becomes smaller, a difficulty of injection molding increases. Therefore, it is difficult to achieve the miniaturization of metal plate resistor.

Therefore, it is an object of the present invention to provide a metal plate resistor and a method for manufacturing the metal plate resistor capable of miniaturization.

### Solution to Problem

In an embodiment, there is provided a metal plate resistor comprising: a plate-shaped resistive element made of a metal material; a pair of electrodes provided at both end portions of the resistive element; and a mold body configured to cover the resistive element, the resistive element has: a first slit extending a width direction from one side of the resistive element and formed on one electrode side; a second slit extending the width direction from the other side of the resistive element and formed on the other electrode side; and a through hole disposed between the first slit and the second slit.

In an embodiment, the mold body has a gate mark formed on an opposite side of the side of the resistive element, the first slit or the second slit being formed the side of the resistive element.

In an embodiment, the resistive element has a plate shape extending straight in a longitudinal direction of the resistive element, the mold body has: an upper thick portion disposed above the resistive element; and a lower thick portion disposed below the resistive element, and the upper thick portion has the same thickness as the lower thick portion or a thickness thicker than the lower thick portion.

In an embodiment, the pair of electrodes is formed by metal plating covering both end portions of the resistive element, and each of the pair of electrodes has a lower surface portion, the lower surface portion being arranged at the same height as a lower surface of the mold body or lower than the lower surface of the mold body.

In an embodiment, there is provided a method for manufacturing a metal plate resistor, comprising: preparing a long resistive element material made of a metal material; forming a first slit extending from one side of the resistive element material, a second slit extending from the other side of the resistive element material, and a through hole disposed between the first slit and the second slit; forming a mold body covering a portion of the resistive element material and fills the first slit, the second slit, and the through hole; cutting the resistive element material so that the portion of the resistive element material is exposed from the mold body; and forming electrodes by metal plating covering both end portions of the resistive element material exposed from the mold body.

### Advantageous Effects of Invention

By forming a through hole in a resistive element (a resistive element material), a fluidity of a resin poured into a space (mold space) where a mold body that covers part of the resistive element (a resistive element material) is formed can be improved. Therefore, a high-quality metal plate resistor can be manufactured with high precision by injection molding. As a result, the metal plate resistor can be made smaller.

### BRIEF DESCRIPTION OF DRAWINGS

FIG. 1 is a view showing an embodiment of a metal plate resistor;

FIG. 2A is a cross-sectional view taken along line A-A in FIG. 1;

FIG. 2B is an enlarged cross-sectional view of a electrode;

FIG. 2C is a view showing other embodiments of a mold body;

FIG. 2D is a view showing other embodiments of the mold body;

FIG. 3 is a flowchart showing a manufacturing process of the resistor;

FIG. 4 is a view showing one embodiment of a resistive element material;

FIG. 5 is a view showing the resistive element material before and after press processing;

FIG. 6 is a view showing a process for forming the mold body;

FIG. 7A is a view showing the mold body formed by pouring resin into a cavity in a mold through a gate;

FIG. 7B is a side view of the resistor in FIG. 7A;

FIG. 8A is a view showing a change over time of a resin poured into the space;

FIG. 8B is a view showing a change over time of the resin poured into the space;

FIG. 8C is a view showing a change over time of the resin poured into the space;

FIG. 9A is a view showing how the long resistive element material is cut;

FIG. 9B is a view showing a cut resistor;

FIG. 10A is a view showing another embodiment of the resistor; and

FIG. 10B is a view showing another embodiment of the resistor.

### DESCRIPTION OF EMBODIMENTS

Hereinafter, embodiments of the present invention will be described with reference to the drawings. In the drawings described below, identical or corresponding components are designated by the same reference numerals, and duplicated descriptions will be omitted. In the multiple embodiments described below, the configuration of an embodiment that is not particularly described is the same as that of other embodiments, and therefore duplicated descriptions will be omitted.

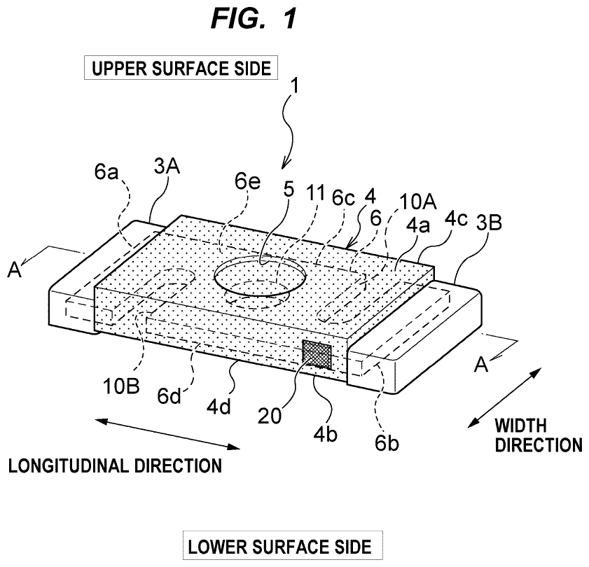

FIG. 1 is a view showing an embodiment of a metal plate resistor. The metal plate resistor 1 is, for example, a surface-mount resistor mounted on a printed circuit board. Hereinafter, the metal plate resistor 1 may be simply referred to as resistor 1. As shown in FIG. 1, the resistor 1 includes a plate-shaped resistive element 6 made of a metal material (e.g., an alloy such as a copper—manganese alloy, a copper—nickel alloy, or a nickel—chromium alloy), a pair of electrodes 3A, 3B provided on both end portions 6a, 6b of the resistive element 6, and a mold body 4 made of a thermoplastic resin that covers the resistive element 6. In this embodiment, the resistor 1 has nominal dimensions of 3.2 mm in a longitudinal direction, 1.6 mm in a width direction, and 0.6 mm in thickness. For example, the mold body 4 may be made of a thermosetting resin.

The resistive element 6 has a plate shape that extends linearly in its longitudinal direction. The longitudinal direction of the resistive element 6 is perpendicular to the width direction of the resistive element 6. The resistive element 6 has a first slit 10A extending in the width direction from one side surface 6c, a second slit 10B extending in the width direction from the other side surface 6d, and a through hole 11 disposed between the first slit 10A and the second slit 10B.

In the embodiment shown in FIG. 1, the first slit 10A is formed on the side of one electrode 3B, and the second slit 10B is formed on the side of the other electrode 3A. In one embodiment, the first slit 10A may be formed on the side of electrode 3A, and the second slit 10B may be formed on the side of electrode 3B.

The first slit 10A and the second slit 10B restrict a flow path of current passing through the resistive element 6. Therefore, by forming the first slit 10A and the second slit 10B, it is possible to adjust the resistance value of the resistor 1. The sizes of the first slit 10A and the second slit 10B may be determined based on the desired resistance value.

The through hole 11 is formed in a central portion of the resistive element 6, and the first slit 10A and the second slit 10B are arranged on either side of the through hole 11. Therefore, the first slit 10A, the second slit 10B, and the through hole 11 are arranged in the longitudinal direction in the order of the first slit 10A, the through hole 11, and the second slit 10B from the electrode 3B side.

The pair of electrodes 3A, 3B are formed by metal plating that covers both end portions 6a, 6b of the resistive element 6. For example, each of the electrodes 3A, 3B has a copper-plated lower layer and a tin-plated upper layer. To ensure solder wettability while reducing costs, the tin-plated upper layer has a predetermined thickness. The electrodes 3A, 3B have the same structure. For example, a middle layer plated with another metal (e.g., nickel) may be provided between the copper-plated lower layer and the tin-plated upper layer.

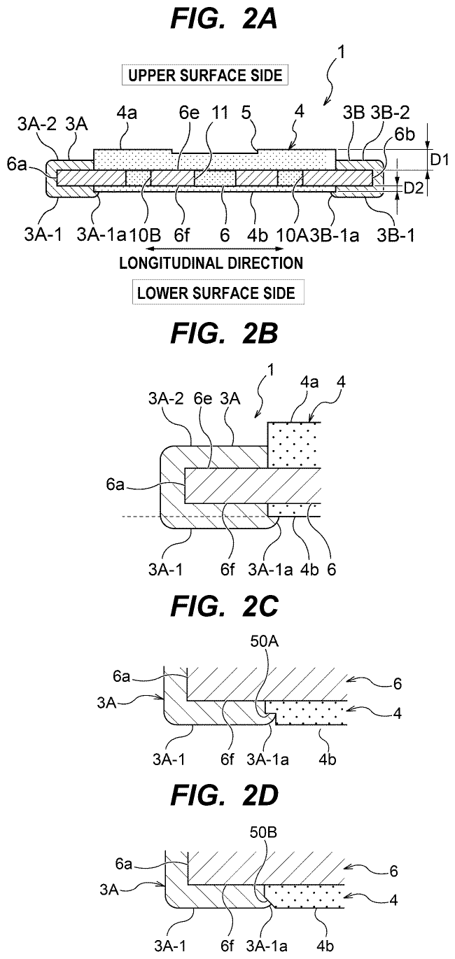

FIG. 2A is a cross-sectional view taken along line A-A in FIG. 1, FIG. 2B is an enlarged cross-sectional view of the electrode, and FIG. 2C and FIG. 2D are views showing other embodiments of the mold body. As shown in FIG. 2A, the electrode 3A (and electrode 3B) has an upper surface portion 3A-2 (and upper surface portion 3B-2) arranged above the resistive element 6 and a lower surface portion 3A-1 (and lower surface portion 3B-1) arranged below the resistive element 6.

The mold body 4 has an upper thick portion 4a arranged above the resistive element 6 (i.e., on an upper surface 6e side of the resistive element 6) and a lower thick portion 4b arranged below the resistive element 6 (i.e., on a lower surface 6f side of the resistive element 6). The upper surface portion 3A-2 of the electrode 3A is in close contact with the upper thick portion 4a of the mold body 4, and the lower surface portion 3A-1 is in close contact with the lower thick portion 4b. The upper surface portion 3B-2 of the electrode 3B is in close contact with the upper thick portion 4a of the mold body 4, and the lower surface portion 3B-1 is in close contact with the lower thick portion 4b.

The lower surface portion 3A-1 (and the lower surface portion 3B-1) is disposed at the same height as the lower surface of the mold body 4 (more specifically, the lower surface of the lower thick portion 4b) or lower than the lower surface of the mold body 4. In the embodiment shown in FIGS. 2A and 2B, the entire lower surface portion 3A-1 (and the lower surface portion 3B-1) is disposed lower than the lower surface of the mold body 4, but in one embodiment, a portion of the lower surface portion 3A-1 (and the lower surface portion 3B-1) may be disposed lower than the lower surface of the mold body 4.

In particular, as shown in FIG. 2B, the electrode 3A has a riding portion 3A-1a formed on its lower surface 3A-1 that rides on the mold body 4. Similarly, the electrode 3B has a riding portion 3B-1a formed on its lower surface 3B-1 that rides on the mold body 4. By forming the riding portion 3A-1a (and the riding portion 3B-1a) in this manner, it is possible to prevent the mold body 4 from peeling off from the resistive element 6.

In the embodiment shown in FIGS. 2C and 2D, the resistor 1 has a lower surface portion 3A-1 (and lower surface portion 3B-1) that is arranged at the same height as the lower surface of the mold body 4, and an electrode 3A (and electrode 3B) that has the riding portion 3A-1a (and riding portion 3B-1a) formed on the lower surface portion 3A-1 (and lower surface portion 3B-1).

In the embodiment shown in FIG. 2C, the mold body 4 has a step portion 50A formed on its lower surface, and the riding portion 3A-1a rides up on the step portion 50A. In the embodiment shown in FIG. 2D, the mold body 4 has a chamfered portion 50B formed on its lower surface, and the riding portion 3A-1a rides up on the chamfered portion 50B.

Although not shown, the step portion 50A (or the chamfered portion 50B) is also formed on the side of the riding portion 3B-1a. Therefore, the riding portion 3B-1a also rides up on the step portion 50A (or the chamfered portion 50B).

With the configuration shown in FIGS. 2C and 2D, the lower surface portion 3A-1 (and the lower surface portion 3B-1) is arranged at the same height as the lower surface of the mold body 4, and the electrode 3A (and the electrode 3B) has a riding portion 3A-1a (and the riding portion 3B-1a) formed on the lower surface portion 3A-1 (and the lower surface portion 3B-1).

In the embodiment shown in FIG. 2A, a thickness D1 of the upper thick portion 4a (i.e., a distance between the upper surface of the resistive element 6 and the upper surface of the mold body 4) is greater than a thickness D2 of the lower thick portion 4b (i.e., a distance between the lower surface of the resistive element 6 and the lower surface of the mold body 4). In other words, the upper thick portion 4a has a greater thickness than the lower thick portion 4b.

It is preferable that the thickness of the lower thick portion 4b always be constant even if the thickness of the resistive element 6 is changed according to the desired resistance value. In other words, it is preferable that as the mold body 4, even if the thickness of the resistive element 6 is changed, only the thickness of the upper thick portion 4a changes. With this configuration, even if the thickness of the resistive element 6 is changed according to the desired resistance value, the resistor 1 can be stably mounted without changing the height and the shape of the lower surface (mounting surface) of the resistor 1. In one embodiment, the upper thick portion 4a may have the same thickness as the lower thick portion 4b.

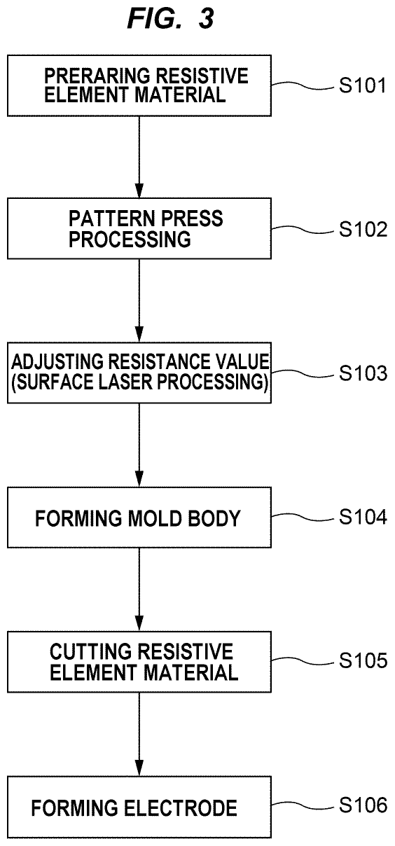

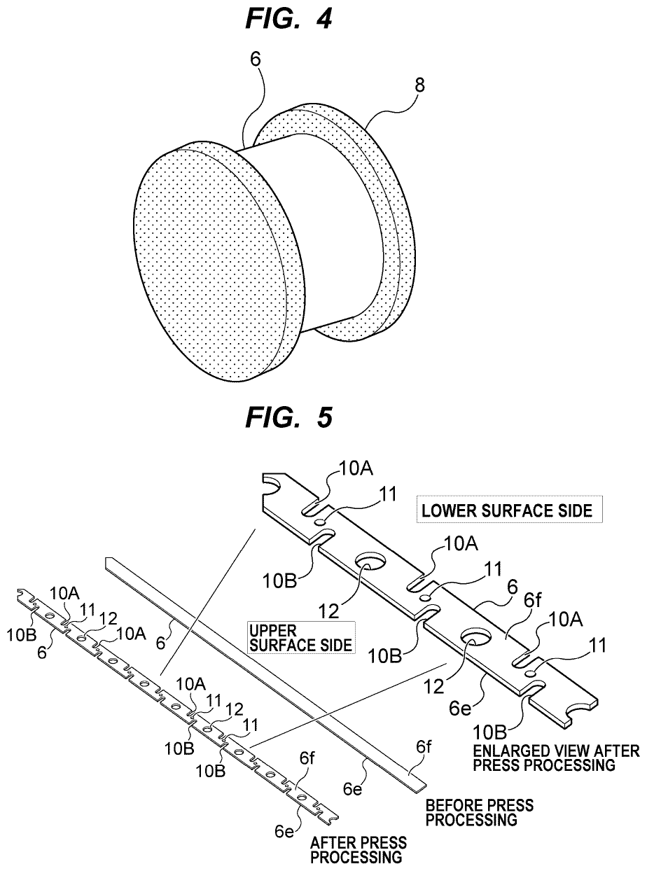

FIG. 3 is a flowchart showing a manufacturing process of the resistor. FIG. 4 is a view showing one embodiment of a resistive element material. As shown in step S101 of FIG. 3 and FIG. 4, a long resistive element material made of a metal material is prepared. The resistive element material constitutes the resistive element 6. In the embodiment shown in FIG. 4, the long resistive element material is wound around a bobbin 8 serving as a winding frame. There are various types of resistive element materials having various thicknesses, and a resistive element material having an optimum thickness is determined appropriately depending on the desired resistance value.

In this embodiment, the resistive element material having a thickness of 0.12 to 0.3 mm is appropriately selected and used. A width of the resistive element material is 1.4 mm. If the thickness is thinner than 0.12 mm, a rigidity of the resistive element 6 decreases, and the resistive element will deform during injection molding regardless of whether or not slits are present. If the thickness is thicker than 0.3 mm, it becomes difficult to form slits and through holes.

FIG. 5 is a view showing the resistive element material before and after press processing. As shown in FIG. 5, the resistive element material before press processing is a long flat plate. As shown in step S102 of FIG. 3 and FIG. 5, pattern press processing is performed on the resistive element material to form a positioning hole 12, a through hole 11, and slits 10A and 10B in the resistive element material.

More specifically, a punching machine (not shown) is used to punch the resistive element material from its lower surface to its upper surface (i.e., from the lower surface 6f to the upper surface 6e of the resistive element 6) to form the positioning hole 12, the through hole 11, and the slits 10A and 10B. For example, at least one or all of the through hole 11 and the slits 10A and 10B may be formed by laser processing.

The positioning hole 12 are used to precisely position the through hole 11, the slits 10A and 10B, and the mold body 4, and are formed first. After step S102 in FIG. 3, laser processing is performed on the surface (i.e., the upper surface 6e and the lower surface 6f of the resistive element 6) of the resistive element material to fine-tune the resistance value (see step S103). For example, in step S103, the resistance value may be fine-tuned by surface processing such as grinding or sandblasting.

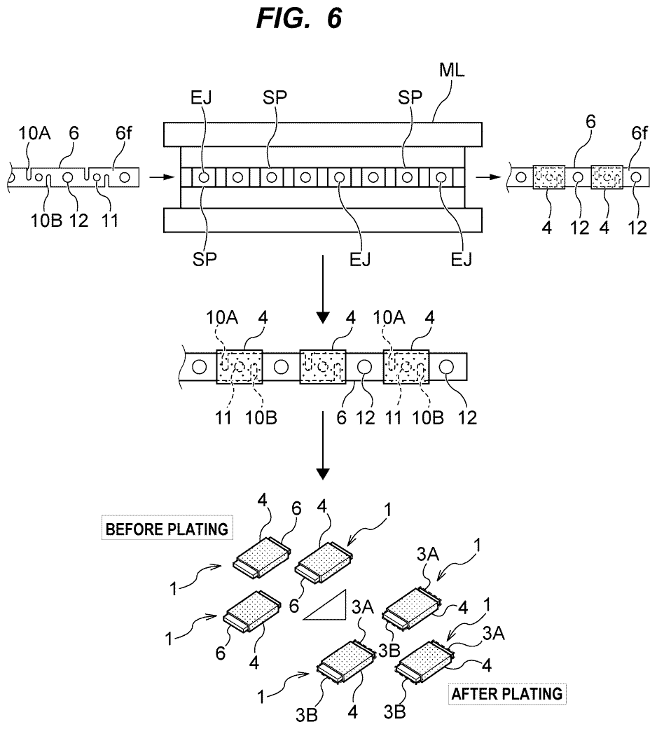

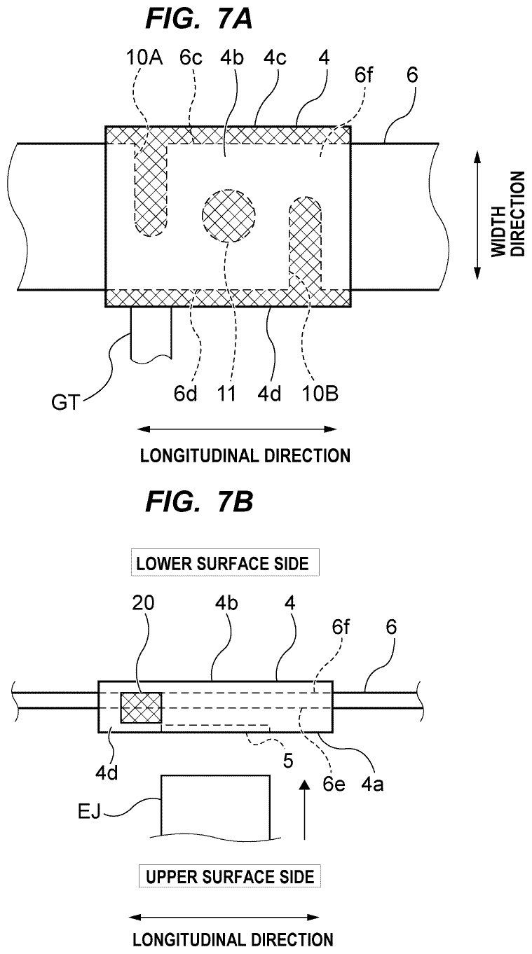

FIG. 6 is a view showing a process for forming a mold body. FIG. 7A is a view showing a mold body formed by pouring resin into a cavity in a mold through a gate, and FIG. 7B is a side view of the resistor in FIG. 7A.

First, the resistive element material is fed into a mold ML for forming the mold body 4 (see FIG. 6). In order to perform injection molding for multiple pieces simultaneously, the mold ML shown in FIG. 6 is a cassette type with multiple pieces arranged, and is incorporated into a lower mold (not shown). The mold ML is attachable to and detachable from the lower mold. There are multiple molds ML corresponding to the thickness of the resistive element 6. Therefore, the optimum mold ML is selected appropriately depending on the thickness of the resistive element 6 and incorporated into the lower mold.

When an upper mold (not shown) is attached to the lower mold incorporating the mold ML, a space SP (i.e., a cavity meaning a recess in the mold into which resin flows) is formed in the portion of the resistive element 6 where the mold body 4 is to be formed (see FIG. 7A). In this embodiment, since multiple injection moldings are performed simultaneously, the mold ML has multiple spaces SP, but the number of spaces SP is not limited to this embodiment.

The resistive element material is fed into the mold ML so that the first slit 10A, the second slit 10B, and the through hole 11 are all contained within one space SP. The upper mold (not shown) is used in common even if the thickness of the resistive element 6 varies. Therefore, the thickness of the lower thick portion can be kept constant even if the thickness of the resistive element 6 varies. In this embodiment, the thickness of the lower thick portion is 0.1 mm.

After the resistive element material is fed into the mold ML, the resin that constitutes the mold body 4 is poured into the space SP through a gate GT (see FIG. 7A) to form the mold body 4 (see step S104 in FIG. 3). The mold body 4 fills the first slit 10A, the second slit 10B, and the through holes 11.

The gate GT is a communication passage for introducing resin into the space SP. By performing injection molding of the mold body 4 through the gate GT, a gate mark 20 is formed on a side of the mold body 4 (see FIG. 7B). After injection molding, the mold body 4 is connected to the gate portion (the resin filled in the gate GT), so it must be separated from the gate portion. The gate mark 20 is a cut mark that is left when the mold body 4 is separated from the gate portion.

As shown in FIGS. 7A and 7B, the mold body 4 has a side surface 4c arranged on the side surface 6c side of the resistive element 6, a side surface 4d arranged on the side surface 6d side of the resistive element 6, and a gate mark 20 formed on the side surface 4d.

More specifically, the gate mark 20 is formed on an opposite side of the resistive element 6. On the side of resistive element 6, the first slit 10A or the second slit 10B is formed. In this embodiment, the gate mark 20 is formed on the side surface 4d, which is located on the side surface 6d opposite to the side surface 6c on which the first slit 10A is formed. In one embodiment, the gate mark 20 may be formed on the side surface 4c, which is located on the side surface 6c opposite to the side surface 6d on which the second slit 10B is formed.

In this manner, when the mold body 4 is formed into the resistive element 6, the gate mark 20 is arranged adjacent to the second slit 10B (or the first slit 10A) in the longitudinal direction of the resistor 1.

Furthermore, the gate mark 20 is arranged on the electrode 3B (or electrode 3A) side in the longitudinal direction (substantially the same position as the first slit 10A (or second slit 10B)). This arrangement can prevent the resistive element 6 from being deformed due to the resin flowing into the space SP through the gate GT.

When pressurized resin is poured into the space SP through the gate GT, the poured resin generates stress in the resistive element 6, i.e., the resistive element material. In this embodiment, the gate GT is disposed on the opposite side of the first slit 10A (or the second slit 10B). More specifically, the gate GT is disposed on the opposite side of the first slit 10A (or the second slit 10B) formed in the side surface 6c (or the side surface 6d) of the resistive element 6, and on the electrode 3B (or electrode 3A) side in the longitudinal direction (substantially the same position as the first slit 10A (or the second slit 10B)).

In this state, if resin is poured into the first slit 10A (or the second slit 10B) from the opposite side through the gate GT, the resin poured into the first slit 10A (or the second slit 10B) can be prevented from directly colliding with the first slit 10A (or the second slit 10B), thereby preventing deformation of the resistive element 6 due to stress generated in the resistive element 6.

On the other hand, if the gate GT is arranged on the same side as the first slit 10A (or the second slit 10B), more specifically, on the same side as the first slit 10A (or the second slit 10B) formed in the side surface 6c (or the side surface 6d) of the resistive element 6 and on the electrode 3B (or electrode 3A) side (approximately the same position as the first slit 10A (or the second slit 10B) in the longitudinal direction), when resin is poured from the first slit 10A (or the second slit 10B) side through the gate GT, the resin may collide with a corner between the side surface 6c (or the side surface 6d) of the resistive element 6 and the side surface of the slit, and may be pushed downward and significantly deformed. Therefore, there is a risk that the resistive element 6 may be deformed due to stress generated in the resistive element 6.

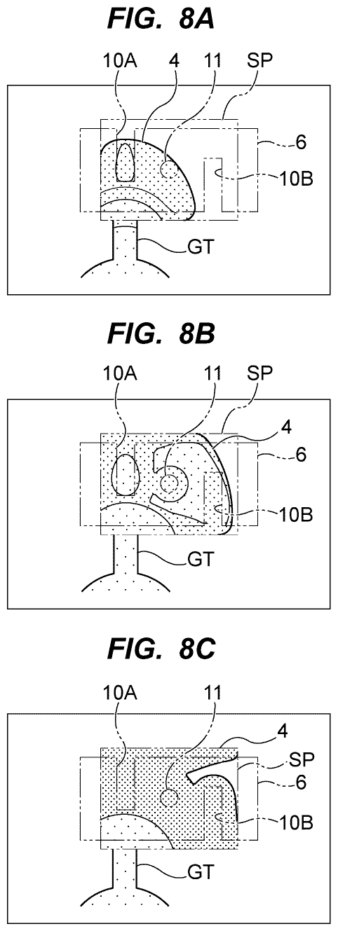

FIGS. 8A to 8C are views showing a change over time of the resin poured into the space. As shown in FIGS. 8A to 8C, by pouring the resin through the gate GT from the electrode 3B (or electrode 3A) side, i.e., from an edge of the space SP, the resin fills an entire space SP without any gaps, and the first slit 10A, the second slit 10B, and the through hole 11 are filled with resin.

The resistor 1 is manufactured by injection molding. More specifically, the resistor 1 is manufactured by coating the resin (more specifically, thermoplastic resin or thermosetting resin) that constitutes the mold body 4 onto the resistive element material (i.e., metal material) that constitutes the resistive element 6. Generally, during the process of filling the cavity with resin, due to the fluidity of the resin, the resin may not be sufficiently filled, resulting in a void (underfill). This phenomenon is called a short shot. The problem of such short shots becomes more pronounced as metal plate resistors become smaller.

According to this embodiment, the through holes 11 formed in the resistive element 6 can improve the fluidity of the resin poured into the space SP in which the resistive element 6 is disposed, thereby suppressing the occurrence of short shots. As a result, a high-quality resistor 1 can be manufactured with high precision by injection molding, and the miniaturization of the resistor 1 can be stably achieved.

In this embodiment, the through hole 11 is circular and has a diameter of 0.3 to 0.7 mm Φ. If the hole diameter is smaller than 0.3 mm Φ, it becomes difficult to form the through hole, and if the hole diameter is larger than 0.7 mm Φ, it becomes difficult to form the through hole because they are positioned too close to the slits.

The first slit 10A and the second slit 10B formed in the resistive element 6 can also achieve the same effect as the through hole 11. More specifically, the slits 10A and 10B formed in the resistive element 6 can improve the fluidity of the resin, similar to the through hole 11, and can suppress the occurrence of short shots.

In this embodiment, the first slit 10A and the second slit 10B each have a depth (widthwise dimension) of 0.3 to 0.9 mm and a width (longitudinal dimension) of 0.3 mm. If the depth is shallower than 0.3 mm, the effect of suppressing short shots is reduced. If the depth is deeper than 0.9 mm, the rigidity of the resistive element 6 is reduced, and the resistive element 6 is deformed during injection molding.

In this embodiment, the gate mark 20 is not arranged on the center side of the mold body 4 in the longitudinal direction of the resistor 1, but is arranged on the electrode 3B (or electrode 3A) side (see FIG. 7B). This arrangement also helps to suppress the occurrence of short shots.

Furthermore, by forming the through hole 11 in the resistive element 6, the upper thick portion 4a and the lower thick portion 4b of the mold body 4 are connected to each other through the through hole 11, thereby improving the adhesion between them (see FIG. 2A). The mold body 4 having such a strong structure can more reliably prevent peeling from the resistive element 6.

In order to improve the adhesion of the mold body 4 to the resistive element 6, it is important to determine the proportion of resin occupying the connection portion (the shaded portion in FIG. 7A) between the upper thick portion 4a and the lower thick portion 4b. For example, the proportion of resin occupying the connection portion is calculated by dividing the area of the connection portion by the area of the horizontal cross section of the mold body 4 and expressing the result as a percentage. The size of the connection portion is determined based on the size of the through hole 11 and the sizes of the slits 10A and 10B.

According to the results of prototype evaluation, a ratio of resin occupying the connection portion is preferably 20% or more. Therefore, in one embodiment, the size of through hole 11 and the sizes of slits 10A and 10B are determined so that the ratio of resin is 20% or more.

As shown in FIGS. 6 and 7B, an ejector pin EJ is disposed in the space SP of the mold ML to remove the mold body 4 from the mold ML. The ejector pin EJ is movable in the vertical direction (see FIG. 7B). By moving the ejector pin EJ upward (i.e., in the direction in which the ejector pin EJ is pressed against the mold body 4), the mold body 4 is pushed out of the mold ML. The mold body 4 is removed from the mold ML by being pushed out.

As shown in FIGS. 1, 2, and 7B, the mold body 4 has an ejector mark 5 formed in its upper thick portion 4a. The ejector mark 5 is formed by contact of the ejector pin EJ with the mold body 4. The ejector mark 5 is formed in the center of the upper thick portion 4a of the mold body 4.

In this embodiment, the resistor 1 is a surface-mount resistor, and is mainly mounted by reflow soldering. If the ejector marks 5 were formed in the lower thick portion 4b of the mold body 4, air (or gas generated from the solder paste) would be trapped in the ejector marks 5 by the flux during reflow soldering, and the resistor 1 would be mounted tilted due to the air (gas). By forming the ejector marks 5 in the upper thick portion 4a of the mold body 4, the resistor 1 is stably mounted without being affected by the ejector marks 5.

When surface-mounting the resistor 1, the upper thick portion 4a of the mold body 4 is suction-mounted using a nozzle. In this embodiment, an inside of the ejector mark 5 is a flat surface. Therefore, even when the upper thick portion 4a of the mold body 4 is suction-mounted, there is no risk of air leaking through the ejector mark 5, and stable mounting is possible.

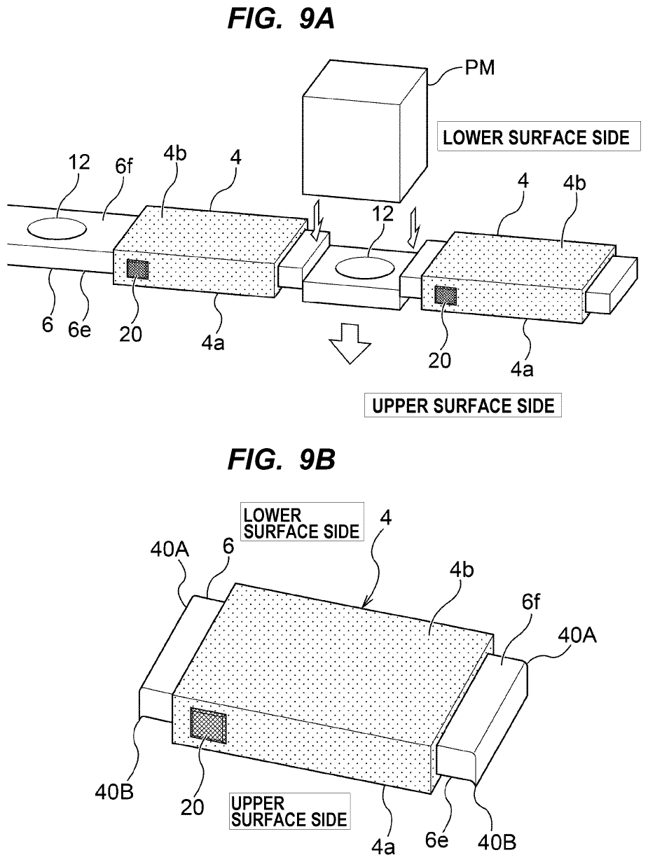

FIG. 9A is a view showing how the long resistive element material is cut, and FIG. 9B is a view showing the cut resistor. As shown in step S105 of FIG. 3 and FIG. 9A, after forming the mold body 4 (see step S104), the resistive element material is cut using a press mold PM (press processing) so that a part of the resistive element material is exposed from the mold body 4.

The press die PM moves from the lower thick portion 4b of the mold body 4 toward the upper thick portion 4a (see the arrow direction in FIG. 9A), and the resistive element material is cut in this direction. As a result of cutting the resistive element material, a sag surface 40A is formed on the lower surface 6f of the resistive element 6, and a burr surface 40B is formed on the upper surface 6e (see FIG. 9B). The sag surface 40A is a smooth cut surface formed on the lower surface 6f. The burr surface 40B is a sharp cut surface formed on the upper surface 6e and protrudes from the upper surface 6e.

If the burr surface 40B were formed on the lower surface 6f of the resistive element 6, the burr surface 40B would protrude from the lower surface 6f. If the burr surface 40B were located on the mounting surface side, the resistor 1 might be mounted tilted due to the burr surface 40B. In this embodiment, the sag surface 40A is formed on the lower surface 6f of the resistive element 6. Even if the sag surface 40A is located on the mounting surface side, it does not adversely affect the mountability of the resistor 1.

As shown in step S106 of FIG. 3 and in FIG. 6, after cutting the resistive element material (see step S105), the electrodes 3A and 3B are formed by metal plating (e.g., electrolytic barrel plating) that covers both end portions of the resistive element material (i.e., both end portions 6a and 6b of the resistive element 6) (see step S106).

More specifically, both end portions 6a, 6b of resistive element 6 are copper-plated, and then both copper-plated end portions 6a, 6b are tin-plated. In this manner, each of electrodes 3A, 3B has a copper-plated lower layer and a tin-plated upper layer. In one embodiment, a middle layer plated with another metal (e.g., nickel) may be provided between the copper-plated lower layer and the tin-plated upper layer.

In this embodiment, the thickness of the copper plating is 0.1 to 0.2 mm, and the thickness of the tin plating is 0.003 to 0.012 mm. If the thickness of the copper plating is thinner than 0.1 mm, the lower surface portion 3A-1 (and lower surface portion 3B-1) of the electrode cannot be positioned at the same height as the lower surface of the mold body 4 (more specifically, the lower surface of the lower thick portion 4b) or lower than the lower surface of the mold body 4. If the thickness of the copper plating is thicker than 0.2 mm, the product will be too thick and will not meet dimensional standards.

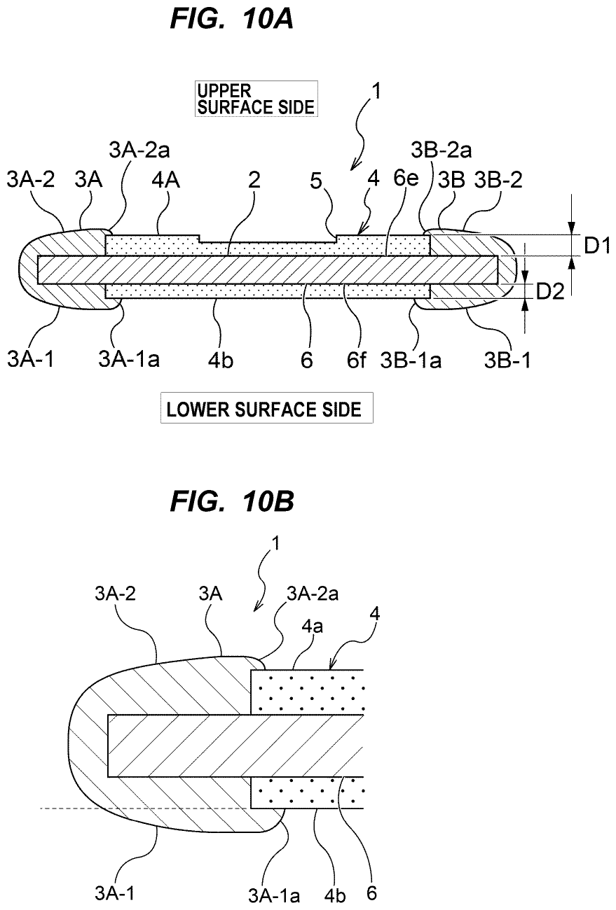

FIGS. 10A and 10B are views showing another embodiment of the resistor. In the embodiment shown in FIGS. 10A and 10B, the thickness D1 of the upper thick portion 4a is also greater than the thickness D2 of the lower thick portion 4b. On the other words, in this embodiment, the electrode 3A (and electrode 3B) has not only a riding portion 3A-1a (and riding portion 3B-la), but also a riding portion 3A-2a (and riding portion 3B-2a) formed on the upper surface portion 3A-2 (and upper surface portion 3B-2) that rides on the mold body 4. This configuration more reliably prevents the mold body 4 from peeling off the resistive element 6.

In one embodiment, the resistor 1 may include a lower surface portion 3A-1 (and lower surface portion 3B-1) that is disposed at the same height as the lower surface of the mold body 4, and the electrode 3A (and electrode 3B) that has the riding portion 3A-la (and riding portion 3B-la) formed on the lower surface portion 3A-1 (and lower surface portion 3B-1). For example, the mold body 4 may have a step portion 50A or a chamfered portion 50B formed on its lower surface (see FIGS. 2C and 2D).

In one embodiment, the resistor 1 may include the upper surface portion 3A-2 (and upper surface portion 3B-2) that is disposed at the same height as the upper surface of the mold body 4, and the electrode 3A (and electrode 3B) that has the riding portion 3A-2a (and riding portion 3B-2a) formed on the upper surface portion 3A-1 (and upper surface portion 3B-1). Although not shown, the mold body 4 may have, for example, the step portion 50A or the chamfered portion 50B formed on its upper surface.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### Industrial Applicability

The present invention is applicable to a metal plate resistor and a method for manufacturing the metal plate resistor.

### Reference Signs List

1 metal plate resistor
3A,3B electrode
3A-1 lower surface portion
3A-1a riding portion
3A-2 upper surface portion
3A-2a riding portion
3B-1 lower surface portion
3B-1a riding portion
3B-2 upper surface portion
3B-2a riding portion
4 mold body
4a upper thick portion
4b lower thick portion
5 ejector mark
6 resistive element
6a,6b both end portions
6c,6d side surface
6e upper surface
6f lower surface
8 bobbin
10A first slit
10B second slit
11 through hole
12 positioning hole
20 gate mark
40A sag surface
40B burr surface
50A step portion
50B chamfered portion
SP space
GT gate
ML mold
PM press mold

1. A metal plate resistor comprising:
a plate-shaped resistive element made of a metal material;
a pair of electrodes provided at both end portions of the resistive element; and
a mold body configured to cover the resistive element,
wherein the resistive element has:
a first slit extending a width direction from one side of the resistive element and formed on one electrode side;
a second slit extending the width direction from the other side of the resistive element and formed on the other electrode side; and
a through hole disposed between the first slit and the second slit.

2. The metal plate resistor according to claim 1, wherein the mold body has a gate mark formed on an opposite side of the side of the resistive element, the first slit or the second slit being formed the side of the resistive element.

3. The metal plate resistor according to claim 1,
wherein the resistive element has a plate shape extending straight in a longitudinal direction of the resistive element,
wherein the mold body has:
an upper thick portion disposed above the resistive element; and
a lower thick portion disposed below the resistive element, and
wherein the upper thick portion has the same thickness as the lower thick portion or a thickness thicker than the lower thick portion.

4. The metal plate resistor according to claim 3, wherein the pair of electrodes is formed by metal plating covering both end portions of the resistive element, and
each of the pair of electrodes has a lower surface portion, the lower surface portion being arranged at the same height as a lower surface of the mold body or lower than the lower surface of the mold body.

5. A method for manufacturing a metal plate resistor, comprising:
preparing a long resistive element material made of a metal material;
forming a first slit extending from one side of the resistive element material, a second slit extending from the other side of the resistive element material, and a through hole disposed between the first slit and the second slit;
forming a mold body covering a portion of the resistive element material and fills the first slit, the second slit, and the through hole;
cutting the resistive element material so that the portion of the resistive element material is exposed from the mold body; and
forming electrodes by metal plating covering both end portions of the resistive element material exposed from the mold body.
